(19) United States
(12) Patent Application Publication
(10) Pub. No.: US 2010/0328733 A1
(43) Pub. Date: Dec. 30, 2010

(54) Tetra-mirror multi-reflection scanning module

(75) Inventors: Ai-Lien Lai, Taipei City (TW); Ching-Yuan Lin, Taipei City (TW); San-Woei Shyu, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: E-PIN OPTICAL INDUSTRY CO., LTD., Taipei (TW)

(21) Appl. No.: 12/576,555

(22) Filed: Oct. 9, 2009

(30) Foreign Application Priority Data
Jun. 30, 2009 (TW) 098122159

(51) Int. Cl. H04N 1/04

(52) U.S. Cl. 358/475

(57) ABSTRACT

The present invention discloses an image scanning module having four reflecting mirrors, the image scanning module comprises at least one source, four reflection mirrors, a pickup lens, an image sensor and a frame, wherein at least one of reflection mirror is multi-reflection along the optical path, satisfies the specific optical conditions. The TTL (total tracking length) can only be adjusted through the arrangement of the distance of the four reflecting mirrors and will not need to adjust through the angle of the four reflecting mirrors. Accordingly, the benefit of present invention not only increases the field of depth by increasing the total length of optical path in the limited space, but also be convenient to assemble respectively to different total tracking length.

### BACKGROUND OF THE INVENTION

1. Field of the Invention

The present invention relates to a tetra-mirror multi-reflection scanning module, and more particularly to a scanning module used for related equipments such as flatbed scanners and multi-function printers.

2. Description of the Related Art

In recent years, scanners, particularly image scanners become important computer peripheral products, and the image scanners can be used for capturing images of a document, a text page, a photo, a film, or even a planar object, etc. The way of capturing images is to project a light onto the document such that the light is reflected from the document to form an image beam, and the image beam is gone through reflections of a plurality of reflection mirrors to change the optical path, and finally focused onto an image sensor by a pickup lens for sensing the image. Since most documents are composed of texts, graphics or a combination of texts and graphics and have areas of different brightnesses, therefore the brightness of a reflected image beam varies with a projection position. After the image beam is focused on a charge-coupled device (CCD) image sensor or a complementary metal-oxide-semiconductor (CMOS) image sensor, the sensing element collects the image beam and converts the image beam into a corresponding photoelectric signal, and a scanning software program reads data of the photoelectric signal, and finally a digital image is formed. A scanned image can be stored in a magnetic storage device (such as a hard disk) or an optical storage device (such as an optical disk). In a standard and common image storage method, formats including tagged image file format (TIFF), encapsulated postscript (EPS), bitmap image file format (BMP), graphics interchange format (GIF) and PC paintbrush exchange (PCX) are adopted. A commercialized scanner such as a flat-bed scanner can be used for scanning photos or printed matters, wherein the scanner includes a cover glass provided for placing a desired scanning document, and a scanning module for converting images of a document into digital data column by column by moving the scanning module along a rail, and this method is generally applied in a scanner. A scanner adopting similar principles such as a multi-function printer scans a document by moving the scanning module with respect to the document.

With reference to FIGS. 1 to 3 for schematic views of a scanning module structure and an optical distance arrangement of different prior arts respectively, the scanning module 91 comprises a cover glass 12, a frame 13, an image sensor 14, a pickup lens 15, a light source 16 and a reflection mirror 917. A light emitted from the light source 16 is projected onto a desired scanning document 2, and reflected from the document 2 to form an image beam, and the image beam is passed through a reflection mirror 917 and arranged to a different position and a different angle to change its direction and path, and finally incident into the pickup lens 15 and the image sensor 14. As user requirements and related manufacturing technologies advance, the scanning module 91 becomes increasingly lighter, thinner, shorter and smaller, and the volume of the image module 91 and the installing space of internal components become smaller and smaller. As to the pickup lens 15 and the image sensor 14 having the same resolution, a polygon mirror can be installed in a limited space of the scanning module 91, such that a scanning light can go through reflections for several times and enter into the scanning module to increase the optical distance in order to increase the depth of field. Although this method can provide a better image from scanning a non-flat document 2 such as a crumpled document, yet the image beam reflected from the document may produce overlapped light beams and entered into the pickup lens 15 after several times of reflections, and thus the overlapped light beams will be overlapped with the original image to produce a ghost image. Traditional solutions are disclosed in U.S. Pat. Nos. 5,815,329, 6,170,651, 6,421,158 and 6,227,449 and U.S. Pub Nos. 2008/0007810 and 2008/0170268; Japan Pat. Nos. 6006524, 2005-328187 and 2004-274299; Great Britain Pat. No. 2317293; and Taiwan Pat. No. 476494 as shown in FIG. 1 or U.S. Pub Nos. 2009/0034024 and 2009/0015883, wherein four reflection mirrors 917 are used, and each reflection mirror 917 reflects an image beam for one time. In FIG. 2, three reflection mirrors 917 are used, and one of the reflection mirrors 917 reflects the image beam for two times. In FIG. 3, four reflection mirrors 917 are used, and one of the reflection mirrors 917 reflects the image beam for two times, and a non-reflecting substance is disposed in the middle of the reflection mirror to prevent any reflection of the overlapped light beam. Alternatively, the angle of a surface of a first reflection mirror is limited to prevent the overlapped light beam from entering into a long and wide reflection mirror as disclosed in U.S. Pub No. 2008/0084625.

In the prior art, it is necessary to rearrange the distance and angle of each reflection mirror when a pickup lens having a different effective focal length (EFL) causes a change of total tracking length (TTL), or when a scanning module is applied to a different branded scanner or when a scanning size of a scanner is changed (such as changing the size between A4 and A3 scanners). In the limited space, it is necessary to adjust the angle and position of each reflection mirror, such that the pickup lens can focus a scanning light, and also adjust the angle and position of each reflection mirror to eliminate or reduce the occurrence of ghost images. To broaden the scope of applicability of the scanning modules with the aforementioned conditions, designers and manufacturers have to rearrange the angle and position of the reflection mirror, or even change the optical path of the reflection mirror. Such adjustment requires manufacturing a new mold for the frame and incurs a higher manufacturing cost. Furthermore, the angle of reflection for a large number of reflection mirrors must satisfy the conditions of the optical path and must be adjusted to eliminate the ghost image, and thus the prior art fails to lower the assembling cost and causes limitations and inconvenience to applications. Therefore, the development of a simple and easy scanning module that requires the least adjustment of the reflection mirrors and fits different branded scanners, different sized scanners (such as A4/A3 scanners), pickup lenses of different effective focal lengths and different total tracking lengths (TTL) demands immediate attentions.

### SUMMARY OF THE INVENTION

Therefore, it is a primary objective of the present invention to overcome the foregoing shortcomings of the prior art by providing a tetra-mirror multi-reflection scanning module to increase the depth of field and broaden the scope of applicability.

The tetra-mirror multi-reflection scanning module of the present invention mainly uses four reflection mirrors to change the direction and path of reflections of an image of a desired scanning document to increase the optical distance. With the arrangement of the four reflection mirrors, an overlapped light beam is prevented from entering into a pickup lens to reduce the occurrence of ghost images. The tetra-mirror multi-reflection scanning module of the present invention comprises at least one light source, four reflection mirrors, a pickup lens, an image sensor and a frame. The light source is a cold cathode fluorescent lamp, a light emitting diode (LED) lamp or a xenon lamp, and there may be one or more light sources. One of the four reflection mirrors reflects the image light for at least two times, and the optical path is Li (Obj, a desired scanning document)→M1→M2→M3→M2→M4→Lo (Img, an image sensor), satisfying the optical conditions of:

$$\begin{matrix}0.7 \leq \frac{{D}_{refl}}{2 ( TTL - {D}_{refl} )} \leq 1.0 ; & ( 1 ) \\ - \frac{1}{2} \cdot \frac{π}{( p + 1 )} \leq {\sum }_{i = 1}^{p} {α}_{i} - \frac{π}{2} ( p + \frac{1}{2} ) \leq \frac{1}{2} \cdot \frac{π}{( p + 1 )} ; & ( 2 )\end{matrix}$$

where, p is the total number of reflections in the optical path; TTL is the total tracking length TTL=Dᵢ+D₁+D₂+D₃+D₄+D_{O}; D_{refl} is the total distance of between four reflection mirrors along the optical path; D_{refl}=D₁+D₂+D₃+D₄; and αᵢ is an included angle between the normal line of the i^{th} reflection mirror reflection surface in the optical path and the +Z-axis, Di is the distance from the reflection mirror M1 to the surface of desired scanning document along the optical path, Do is the distance from the last reflection mirror M4 to the surface of image sensor along the optical path, D₁, D₂, D₃, D₄ are the distances from the previously reflection mirror to the next reflection mirror along the optical path.

Therefore, the tetra-mirror multi-reflection scanning module of the present invention has one or more of the following advantages:

(1) The four reflection mirrors are provided for reflecting the image beam, and at least one reflection mirror reflects the beam for several times to increase the total tracking length, and the angle and position of the reflection mirrors are arranged to reduce or eliminate an overlapped light beam produced by several times of reflections from the reflection mirrors in order to reduce the occurrence of ghost images.

(2) With the optical path of the four reflection mirrors, we can simply adjust the positions of the reflection mirrors to fit scanners with different total tracking lengths, different sizes (such as A4/A3) or pickup lenses with different effective focal lengths. The invention simply requires adjusting the relational positions of the reflection mirrors to project the image beam Lo into the pickup lens along the optical axis of the pickup lens to broaden the scope of applicability of the present invention.

(3) The positions of the reflection mirrors are adjusted to fit the effective focal length and the total tracking length of the pickup lens, so as to minimize the volume of the frame and meet the requirements of a compact design.

### BRIEF DESCRIPTION OF THE DRAWINGS

FIG. 1 is a schematic view of a first conventional scanning module;

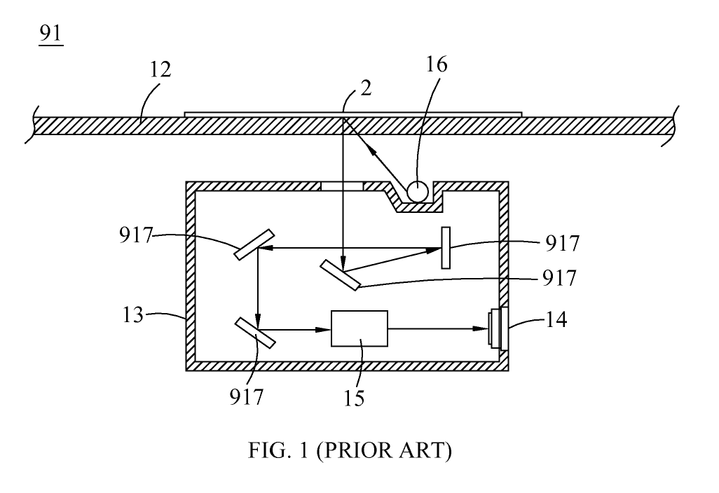

FIG. 2 is a schematic view of a second conventional scanning module;

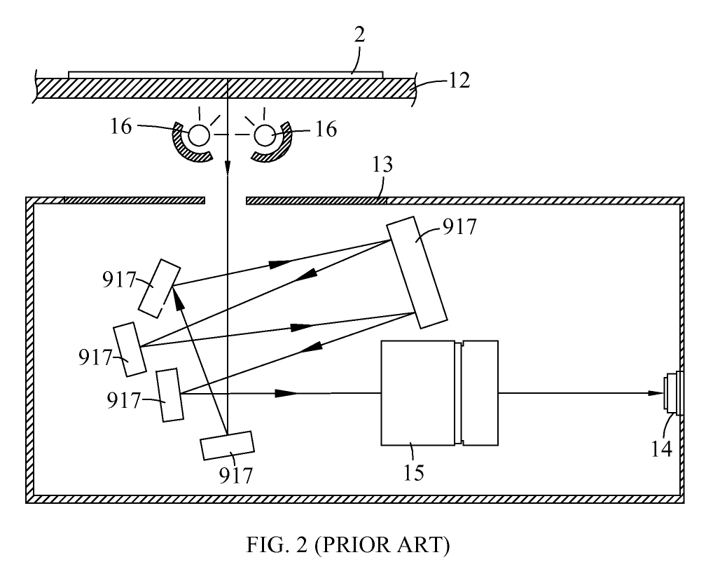

FIG. 3 is a schematic view of a third conventional scanning module;

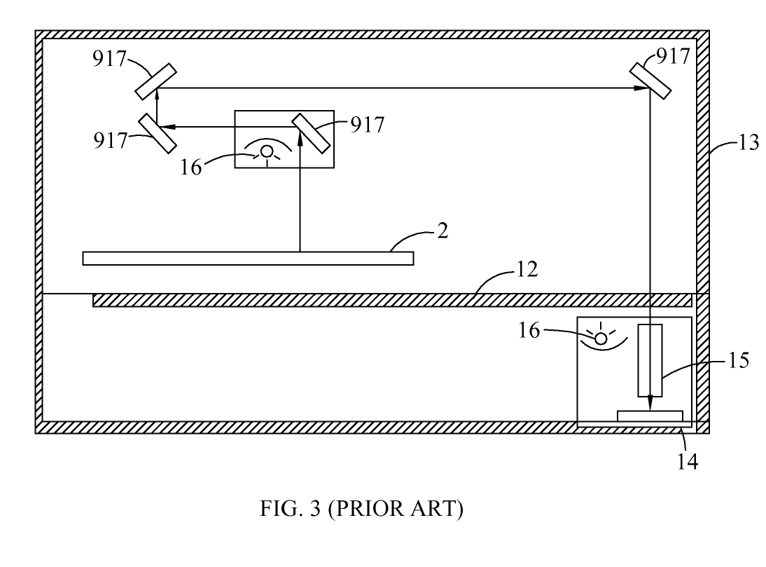

FIG. 4 is a schematic view of a tetra-mirror multi-reflection scanning module in accordance with a first preferred embodiment of the present invention;

FIG. 5 is a schematic view showing angles of reflection mirrors of a tetra-mirror multi-reflection scanning module in accordance with the present invention;

FIG. 6 is a schematic view of eliminating an overlapped light beam on an optical path of M2→M3 of a tetra-mirror multi-reflection scanning module in accordance with the present invention; and

FIG. 7 is a schematic view of a tetra-mirror multi-reflection scanning module in accordance with a fourth preferred embodiment of the present invention.

### DETAILED DESCRIPTION OF THE PREFERRED EMBODIMENTS

The structure and technical characteristics of the present invention will become apparent in the following detailed description of the preferred embodiments with reference to the accompanying drawings.

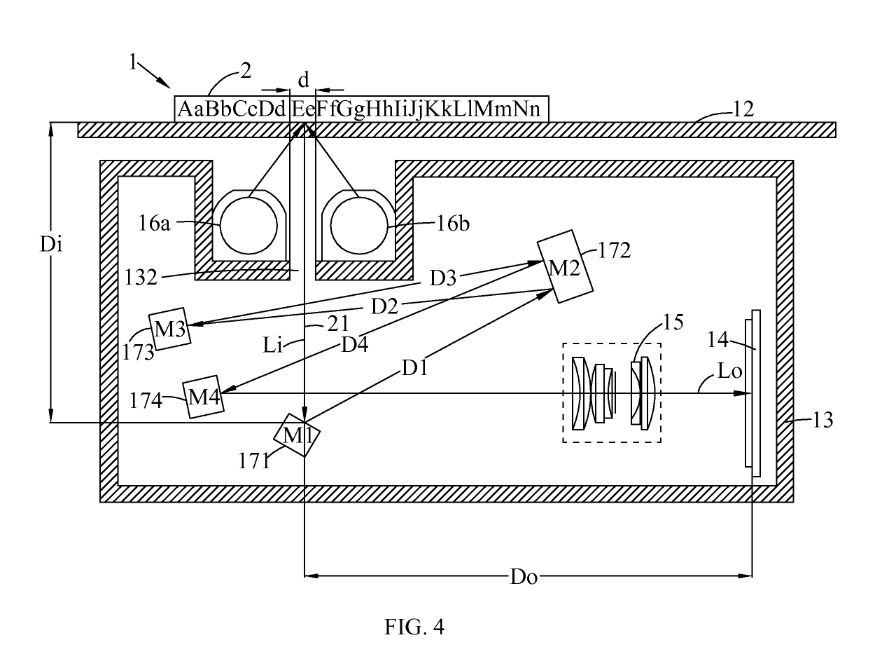

With reference to FIG. 4 for a tetra-mirror multi-reflection scanning module of the present invention, the tetra-mirror multi-reflection scanning module 1 comprises two light sources 16a, 16b, four reflection mirrors (M1, M2, M3, M4) 171˜174, a pickup lens 15, an image sensor 14 and a frame 13. After the light source 16 (16a, 16b) emits a light, the light is passed through a cover glass 12 and projected onto a desired scanning document 2. The light is reflected from the desired scanning document 2 to form a reflected light. The reflected light is passed through the cover glass 12 to form an image beam Li 21 incident into the scanning module 1, and the image beam Li 21 is incident into the first reflection mirror (M1) 171 to constitute a first reflection, and then incident into the second reflection mirror (M2) 172 to constitute a second reflection, and then incident into the third reflection mirror (M3) 173 to constitute a third reflection, and then incident into the second reflection mirror (M2) 172 again to constitute a fourth reflection, and then incident into the fourth reflection mirror (M4) 174 to constitute a fifth reflection, and finally form an image beam Lo incident into the pickup lens 15, wherein the optical path is Li (Obj, or the desired scanning document)→M1→M2→M3→M2→M4→Lo (Img, or the image sensor), and the second reflection mirror (M2) 172 is multi-reflection which reflects lights for one more time.

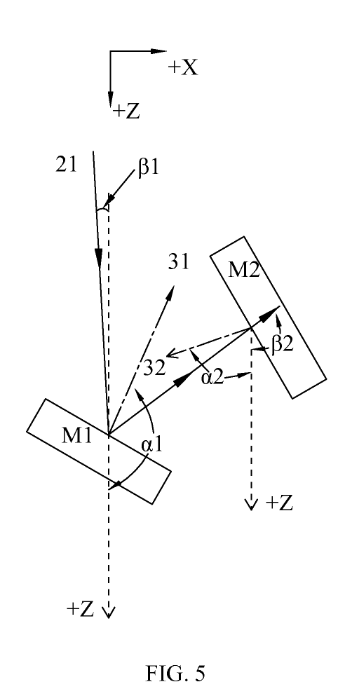

The present invention provides a tetra-mirror multi-reflection scanning module as shown in FIG. 4 and comprises at least one light source, four reflection mirrors, a pickup lens, an image sensor and a frame. On the plane X-Z, half of the total distance between the reflection mirrors and the total tracking length (TTL) satisfy the conditions of:

$$0.7 \leq \frac{{D}_{refl}}{2 ( TTL - {D}_{refl} )} \leq 1.0 ;$$

where, TTL is the total tracking length TTL=Dᵢ+D₁+D₂+D₃+D₄+D_{O}; D_{refl} is the total distance between reflection mirrors along the optical path as shown in FIG. 4 and D_{refl}=D₁+D₂+D₃+D₄. The angular relation between reflection mirrors satisfies:

$$- \frac{1}{2} \cdot \frac{π}{( p + 1 )} \leq {\sum }_{i = 1}^{p} {α}_{i} - \frac{π}{2} ( p + \frac{1}{2} ) \leq \frac{1}{2} \cdot \frac{π}{( p + 1 )} ;$$

Where, αᵢ is an included angle (deg.) between the normal line of the i^{th} reflection mirror reflection surface of the optical path and the +Z-axis as shown in FIG. 5; and p is the total number of reflections along the optical path and p=5 as shown in FIG. 4.

$${\sum }_{i = 1}^{p} {α}_{i} - \frac{π}{2} ( p + \frac{1}{2} ) = ( {α}_{1} + {α}_{2} + {α}_{3} + {α}_{2} + {α}_{4} ) - \frac{π}{2} ( 5 + \frac{1}{2} ) ; \qquad ( 3 )$$

The positional relation between reflection mirrors is determined by the coordinates (M_{iX}, M_{iZ}) of a reflection point of the previous reflection mirror, the angle of the reflection mirror, and the angle of light incident into the reflection mirror:

M_{(i+1)X}=M_{iX}−Dᵢ sin(180±(2αᵢ+βᵢ))

M_{(i+1)Z}=M_{iZ}−Dᵢ Cos(180±(2αᵢ+βᵢ)); (4)

where, (M_{iX}, M_{iZ}) are (X, Z) coordinates of a reflection point of the i^{th} reflection mirror; and βᵢ is an included angle (deg.) between an image beam of the i^{th} reflection mirror and the +Z-axis as shown in FIG. 5.

To reduce the volume of the frame while maintaining the total tracking length unchanged effectively, the present invention adopts multi-reflections for the reflection mirrors, wherein the reflection mirror (M2) 172 reflects the image beam for two times. In the prior art, a serious overlapped light beam will be produced to form a ghost image after several times of reflections from the reflection mirrors, and thus it is necessary to set or adjust the width and angle of the reflection mirrors appropriately to reduce the overlapped light beam. In the tetra-mirror multi-reflection scanning module in accordance with the present invention, the optical path M2→M3 of a multi-refection reflection mirror surface has a relatively longer distance and the reflection points at the multi-refection reflection mirror surfaces have relatively shorter distances to reduce the overlapped light beam effectively.

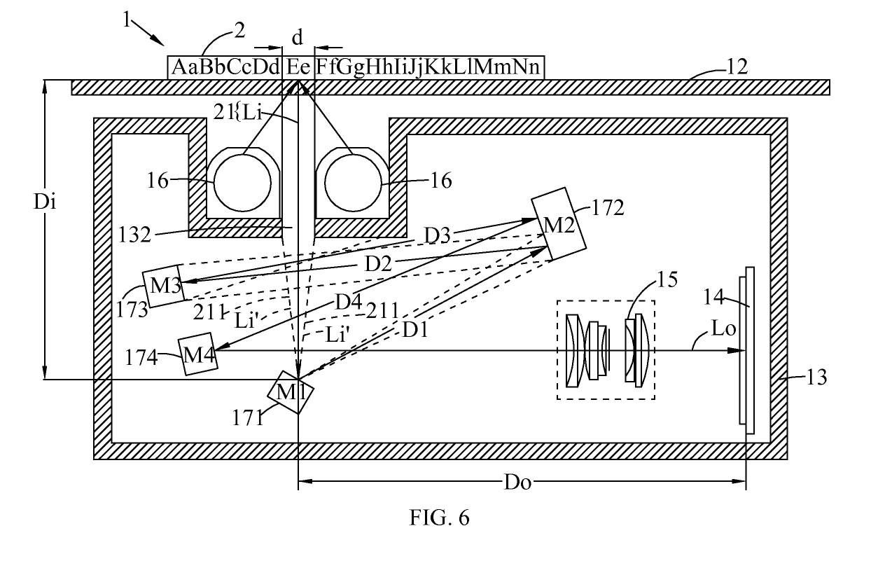

In FIG. 6, the light emitted by the light source 16 is passed through a cover glass 12 and projected onto a desired scanning document 2, and a reflecting light produced by the light projected onto the desired scanning document 2 and passed through the cover glass 12 forms an image beam Li 21 incident into a scanning module 1. The image beam Li′ 211 passed through an aperture 132 of a frame is an overlapped light beam reflected from a first reflection mirror (M1) 171 for the first time, and then a different reflecting angle of the reflected light of the image beam Li is produced, and the reflected light is further reflected by a second reflection mirror (M2) 172 and a third reflection mirror (M3) 173, such that the reflected light exceeding the range of reflection of the second reflection mirror (M2) 172 for the multi-reflections is eliminated. The overlapped light beam Li′ 211 is affected by the angle of the incident light at each reflection mirror surface and the angle of the reflection mirror surface and thus it is eliminated. In other words, the factor of overlapped light beam (FOL) is related to the diameter d of the aperture, the angle of the reflection mirror, and the width of the reflection mirror surface. On the reflection mirror (M3) 173, a best effect of eliminating the factor of overlapped light beam (FOL) can be achieved if Equation (5) is satisfied:

$$\begin{matrix}FOL = \frac{sin ( {α}_{1} ) \cdot sin ( {α}_{2} ) \cdot sin ( {α}_{3} )}{d} \cdot {λ}_{2} \leq \frac{1}{2} ; & ( 5 ) \\ where , {λ}_{2} = \sqrt{{( {M}_{2 X} - {M}_{4 X} )}^{2} + {( {M}_{2 Z} - {M}_{4 Z} )}^{2}} ; & ( 6 )\end{matrix}$$

where, λ₂ is the minimum width of the reflection mirror (M2) 172, represented by the coordinates on the plane X-Z of the reflection points (M_{2X}, M_{2Z}) and (M_{4X}, M_{4Z}) which are coordinates of reflection points of a multi-reflection from the reflection mirror (M2); FOL is the factor of overlapped light beam; and d is the diameter of the aperture.

The tetra-mirror multi-reflection scanning module of the present invention changes the direction and path of the reflection of the image beam of the desired scanning document by the reflection of four reflection mirrors to increase the optical distance, and the distances between the reflection mirrors and the total tracking length (TTL) can satisfy Equation (1), and the sum of included angles between the normal line of the reflection surface of each reflection mirror and the +Z-axis can satisfy Equation (2), such that if the total tracking length is variate, it is necessary to adjust the distance between the reflection mirrors only. Moreover, the angle and distance of the four reflection mirrors can be arranged, such that the reflection mirror (M3) 173 can satisfy Equation (5) to prevent the overlapped light beam from entering into the pickup lens in order to reduce the occurrence of ghost images.

With reference to FIG. 4 for a tetra-mirror multi-reflection scanning module in accordance with a first preferred embodiment of the present invention, the tetra-mirror multi-reflection scanning module 1 comprises two cold cathode fluorescent lamp light sources 16 (16a, 16b), four reflection mirrors M1 (171), M2 (172), M3 (173) and M4 (174), a pickup lens 15, an image sensor 14 and a frame 13, applied to an A4 sized scanning module.

After the light source 16 emits a light, the light is passed through a cover glass 12 and projected onto a desired scanning document 2 (Obj) to form an image beam Li incident into the scanning module 1. The image beam Li is reflected by the reflection mirror (M1) and projected onto the reflection mirror (M2), reflected by the reflection mirror (M2) and projected onto the reflection mirror (M3), reflected by the reflection mirror (M3) and projected onto the reflection mirror (M2), reflected by the reflection mirror (M2) and projected onto the reflection mirror (M4), and reflected by the reflection mirror (M4) to form an image beam Lo. The image beam Lo is focused by the pickup lens 15 to form an image (Img) on the surface of the image sensor 14. The frame 13 is provided for accommodating each component in the scanning module 1. The optical path is Li (Obj)→M1→M2→M3→M2→M4→Lo (Img). An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 1:

TABLE 1
List of Optical Parameters for First Preferred Embodiment

| Surface | αᵢ(° Deg.) | Di(mm) | (M_{iX}, M_{iZ}) |
|---|---|---|---|
| Obj | | 0 | (0, 0) |
| M1 | 150.4 | 51.78 | (0, 51.78) |
| M2 | 70.1 | 35.41 | (30.43, 33.67) |
| M3 | 101.5 | 51.65 | (−20.57, 41.87) |
| M2 | 70.1 | 48.73 | (26.75, 30.20) |
| M4 | 104.8 | 38.98 | (−8.28, 47.31) |
| Img | | 53.45 | (45.17, 47.31) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 satisfies Equation (5), for eliminating the overlapped light beam effectively to prevent the ghost image phenomenon.

$$TTL = {D}_{i} + {D}_{1} + {D}_{2} + {D}_{3} + {D}_{4} + {D}_{O} = 280.0$$

$$\frac{{D}_{refl}}{2 ( TTL - {D}_{refl} )} = 0.8156 \\ - \frac{1}{2} \frac{π}{( 5 + 1 )} \leq {\sum }_{i = 1}^{5} {α}_{i} - \frac{π}{2} ( 5 + \frac{1}{2} ) = - 0.0097 \cdot π$$

$$FOL = 0.4603$$

In a second preferred embodiment which is similar to the first preferred embodiment, except that the A4 sized scanning module is substituted by an A3 sized scanning module as shown in FIG. 4, and a tetra-mirror multi-reflection scanning module 1 in accordance with the second preferred embodiment of the present invention comprises two cold cathode fluorescent lamp light sources 16 (16a, 16b), four reflection mirrors M1 (171), M2 (172), M3 (173) and M4 (174), a pickup lens 15, an image sensor 14 and a frame 13, applied to an A3 sized scanning module. The angles of each reflection mirror and the optical distances are the same as those in the first preferred embodiment, except that the distances between the reflection mirrors are changed to fit the A3 sized scanning module.

An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 2:

TABLE 2
List of Optical Parameters for Second Preferred Embodiment

| Surface | αᵢ(° Deg.) | Di(mm) | (M_{iX}, M_{iZ}) |
|---|---|---|---|
| Obj | | 0 | (0, 0) |
| M1 | 150.4 | 51.78 | (0, 51.78) |
| M2 | 70.1 | 46.01 | (39.54, 28.25) |
| M3 | 101.5 | 62.25 | (−21.92, 38.14) |
| M2 | 70.1 | 59.20 | (35.55, 23.95) |
| M4 | 104.8 | 53.55 | (−12.56, 47.46) |
| Img | | 82.43 | (69.87, 47.46) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 nearly satisfies Equation (5), for eliminating the overlapped light beam effectively to prevent the occurrence of ghost images still.

$$TTL = {D}_{i} + {D}_{1} + {D}_{2} + {D}_{3} + {D}_{4} + {D}_{O} = 355.22$$

$$\frac{{D}_{refl}}{2 ( TTL - {D}_{refl} )} = 0.8118 \\ - \frac{1}{2} \frac{π}{( 5 + 1 )} \leq {\sum }_{i = 1}^{5} {α}_{i} - \frac{π}{2} ( 5 + \frac{1}{2} ) = - 0.0097 \cdot π$$

$$FOL = 0.5332$$

Compared with the first preferred embodiment, this preferred embodiment simply adjusts the overall distance between the reflection mirrors without a need of adjusting the angle of the reflection mirrors in order to adjust the TTL of the first preferred embodiment from 280.0 mm to 355.22 mm to fit the A3 sized scanning module instead of the A4 sized scanning module.

In a third preferred embodiment, this preferred embodiment is applied to an A3 sized scanning module as shown in FIG. 4, and the A3 sized scanning module has a total tracking length (TTL) greater than the total tracking length of the scanning module of the second preferred embodiment, wherein TTL=460 mm in this preferred embodiment, and the distance between the reflection mirrors is adjusted without changing the angle between the reflection mirrors in order to adjust a shorter total tracking length of the scanning module of the second preferred embodiment to a longer total tracking length of the scanning module.

The optical path of this preferred embodiment is the same as that of the second preferred embodiment, which is Li (Obj)→M1→M2→M3→M2→M4→Lo (Img). An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 3:

TABLE 3
List of Optical Parameters for Third Preferred Embodiment

| Surface | αᵢ (° Deg.) | Di(mm) | (M_{iX}, M_{iZ}) |
|---|---|---|---|
| Obj | | 0 | (0, 0) |
| M1 | 150.4 | 63.12 | (0, 63.12) |
| M2 | 70.1 | 60.26 | (51.78, 32.30) |
| M3 | 101.5 | 77.94 | (−25.17, 44.68) |
| M2 | 70.1 | 75.80 | (48.42, 26.52) |
| M4 | 104.8 | 74.23 | (−18.27, 59.11) |
| Img | | 108.65 | (90.38, 59.11) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 nearly satisfies Equation (5), for eliminating the overlapped light beam effectively to prevent the phenomenon of ghost images still.

$$TTL = {D}_{i} + {D}_{1} + {D}_{2} + {D}_{3} + {D}_{4} + {D}_{O} = 460.0$$

$$\frac{{D}_{refl}}{2 ( TTL - {D}_{refl} )} = 0.8390 \\ - \frac{1}{2} \frac{π}{( 5 + 1 )} \leq {\sum }_{i = 1}^{5} {α}_{i} - \frac{π}{2} ( 5 + \frac{1}{2} ) = - 0.0097 \cdot π$$

$$FOL = 0.6084$$

Compared with the second preferred embodiment, this preferred embodiment simply adjusts the overall distance between the reflection mirrors without a need of adjusting the angle of the reflection mirrors in order to adjust the TTL of the first preferred embodiment from 355.22 mm to 460.0 mm to broaden the scope of applicability.

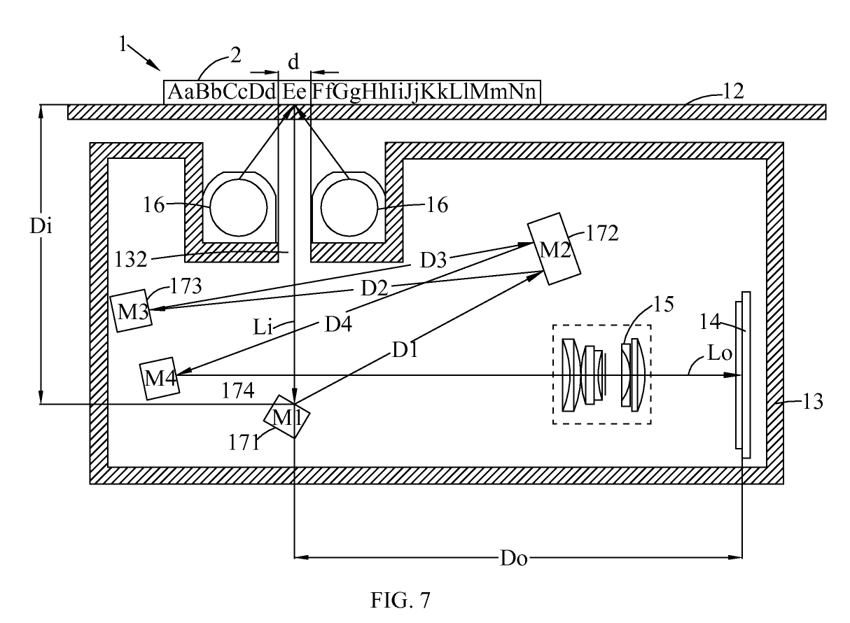

With reference to FIG. 7 for a tetra-mirror multi-reflection scanning module in accordance with a fourth preferred embodiment of the present invention, the tetra-mirror multi-reflection scanning module 1 comprises two cold cathode fluorescent lamp light sources 16, four reflection mirrors (M1) (171), M2 (172), M3 (173) and M4 (174), a pickup lens 15, an image sensor 14 and a frame 13, applied to an A3 sized scanning module.

After the light source 16 emits a light, the light is passed through a cover glass 12 and projected onto a desired scanning document 2 (Obj) to form an image beam Li incident into the scanning module 1. The optical path of this preferred embodiment is the same as those of the first to third preferred embodiments, which is Li (Obj)→M1→M2→M3→M2→M4→Lo (Img). An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 4:

TABLE 4
List of Optical Parameters for Fourth Preferred Embodiment

| Surface | αᵢ (° Deg.) | Di(mm) | (M_{iX}, M_{iZ}) |
|---|---|---|---|
| Obj | | 0 | (0, 0) |
| M1 | 147.6 | 50.78 | (0, 50.78) |
| M2 | 70.6 | 51.74 | (46.83, 28.78) |
| M3 | 105.2 | 51.57 | (−3.28, 40.94) |
| M2 | 70.6 | 49.88 | (44.50, 26.64) |
| M4 | 98.7 | 64.07 | (−14.84, 50.79) |
| Img | | 87.18 | (72.34, 50.79) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 satisfies Equation (5), for eliminating the overlapped light beam effectively to prevent the phenomenon of ghost images.

$$TTL = {D}_{i} + {D}_{1} + {D}_{2} + {D}_{3} + {D}_{4} + {D}_{O} = 355.22$$

$$\frac{{D}_{refl}}{2 ( TTL - {D}_{refl} )} = 0.7398$$

$${\sum }_{i = 1}^{5} {α}_{i} - \frac{π}{2} ( 5 + \frac{1}{2} ) = 0.0133 \cdot π \leq \frac{1}{2} \frac{π}{( 5 + 1 )}$$

$$FOL = 0.3268$$

In a fifth preferred embodiment, this preferred embodiment is similar to the fourth preferred embodiment and applied to an A3 sized scanning module with TTL=460.0 mm, and the distance between the reflection mirrors of the scanning module of the fourth preferred embodiment is adjusted without changing the angle between the reflection mirrors in order to adjust a shorter total tracking length of the scanning module of the fourth preferred embodiment to a longer total tracking length of the scanning module.

The optical path of this preferred embodiment is the same as that of the fourth preferred embodiment, which is Li (Obj)→M1→M2→M3→M2→M4→Lo (Img). An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 5:

TABLE 5
List of Optical Parameters for Fifth Preferred Embodiment

| Surface | αᵢ (° Deg.) | Di(mm) | (M_{iX}, M_{iZ}) |
|---|---|---|---|
| Obj | | 0 | (0, 0) |
| M1 | 147.6 | 68.52 | (0, 68.52) |
| M2 | 70.6 | 61.16 | (55.36, 42.52) |
| M3 | 105.2 | 62.54 | (−5.42, 57.27) |
| M2 | 70.6 | 61.86 | (53.84, 39.53) |
| M4 | 98.7 | 80.94 | (−21.13, 70.03) |
| Img | | 124.98 | (103.85, 70.03) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 satisfies Equation (5), for eliminating the overlapped light beam effectively to prevent the phenomenon of ghost images.

$$TTL = {D}_{i} + {D}_{1} + {D}_{2} + {D}_{3} + {D}_{4} + {D}_{O} = 460.0$$

$$\frac{{D}_{refl}}{2 ( TTL - {D}_{refl} )} = 0.6934$$

$${\sum }_{i = 1}^{5} {α}_{i} - \frac{π}{2} ( 5 + \frac{1}{2} ) = 0.0133 \cdot π \leq \frac{1}{2} \frac{π}{( 5 + 1 )}$$

$$FOL = 0.3268$$

Compared with the fourth preferred embodiment, this preferred embodiment simply adjusts the overall distance between the reflection mirrors without a need of adjusting the angle of the reflection mirrors in order to adjust the TTL of the first preferred embodiment from 355.22 mm to 460.0 mm to broaden the scope of applicability.

In a sixth preferred embodiment, this preferred embodiment is applied to an A3 sized scanning module with TTL=460.0 mm, and the distance between the reflection mirrors of the scanning module of the fifth preferred embodiment is adjusted without changing the angle between the reflection mirrors in order to reduce the volume of the A3 sized scanning module, such that the length along the Z-axis can be reduced by approximately 7 mm, and the length along the X-axis can be reduced by approximately 6 mm.

The optical path of this preferred embodiment is the same as that of the fourth preferred embodiment, which is Li (Obj)→M1→M2→M3→M2→M4→Lo (Img). An included angle αᵢ between the normal line of the reflection surface of each reflection mirror Mᵢ and the +Z-axis, and the coordinates (M_{iX}, M_{iZ}) of the reflection point of the reflection of the of reflection mirror Mi on the plane X-Z are shown in Table 5:

TABLE 6
List of Optical Parameters for Sixth Preferred Embodiment

| Surface | αᵢ (° Deg.) | Di(mm) | (M_{iX}, M_{iZ}) |
|---|---|---|---|
| Obj | | 0 | (0, 0) |
| M1 | 147.6 | 58.52 | (0, 58.52) |
| M2 | 70.6 | 63.56 | (57.53, 31.50) |
| M3 | 105.2 | 65.94 | (−6.55, 47.05) |
| M2 | 70.6 | 61.86 | (52.72, 29.31) |
| M4 | 98.7 | 91.04 | (−31.61, 63.62) |
| Img | | 119.08 | (87.47, 63.62) |

In this preferred embodiment, the total number of reflections p=5, and the total distance between reflection mirrors and the total tracking length satisfy Equation (1), and the sum of angles of each reflection mirror along the optical path satisfies Equation (2), and the multi-refection occurs at the reflecting mirror (M2), and the aperture 132 of the frame 13 has a diameter d=5 mm, and the reflection mirror (M2) 172 nearly satisfies Equation (5), for eliminating the overlapped light beam effectively to prevent the phenomenon of ghost images still.

$$TTL = {D}_{i} + {D}_{1} + {D}_{2} + {D}_{3} + {D}_{4} + {D}_{O} = 460.0$$

$$\frac{{D}_{refl}}{2 ( TTL - {D}_{refl} )} = 0.7522$$

$${\sum }_{i = 1}^{5} {α}_{i} - \frac{π}{2} ( 5 + \frac{1}{2} ) = 0.0133 \cdot π \leq \frac{1}{2} \frac{π}{( 5 + 1 )}$$

$$FOL = 0.5163$$

Compared with the fifth preferred embodiment, this preferred embodiment has a frame with a greater thickness and a significantly smaller length, such that we simply need to adjust the distance between the reflection mirrors to reduce the volume of the image scanner, so as to achieve the requirements for miniaturization.

In summation of the description above, the tetra-mirror multi-reflection scanning module of the present invention uses four reflection mirrors and at least one reflection mirror to form a multi-refection optical path and increase the length of the optical path in order to achieve the effects of increasing the depth of field, and reducing or eliminating the overlapped light beam produced by the multi-reflection of the reflection mirrors, so as to reduce the occurrence of ghost images.

The tetra-mirror multi-reflection scanning module of the present invention also provides a convenient manufacture and assembling, such that manufacturers simply need to adjust the distance between the reflection mirrors without adjusting the angle of the reflection mirrors to fit A4/A3 sizes or different effective focal lengths of the pickup lens to broaden the scope of applicability.

While the invention has been described by means of specific embodiments, numerous modifications and variations could be made thereto by those skilled in the art without departing from the scope and spirit of the invention set forth in the claims.

What is claimed is:

1. A tetra-mirror multi-reflection scanning module, comprising at least one light source, four reflection mirrors, a pickup lens, an image sensor and a frame; wherein the light source is projected onto a desired scanning document to produce an image beam Li incident into the scanning module, and the four reflection mirrors are provided for reflecting the image beam Li to form an image beam Lo incident into the pickup lens, and the pickup lens is provided for focusing the incident image beam Lo onto the image sensor, and the frame is provided for accommodating the light source, the four reflection mirrors, the pickup lens and the image sensor; wherein, the image beam Li, the four reflection mirrors and the image beam Lo constitute an optical path, and at least one of the four reflection mirrors along the optical path reflects a light for two or more times, and satisfies the optical conditions of:
$$- \frac{1}{2} \cdot \frac{π}{( p + 1 )} \leq {\sum }_{i = 1}^{p} {α}_{i} - \frac{π}{2} ( p + \frac{1}{2} ) \leq \frac{1}{2} \cdot \frac{π}{( p + 1 )} ;$$
wherein p is the total number of reflections along the optical path, and αᵢ is an included angle between a normal line of a reflection surface of the i^{th} reflection mirror of the optical path and a +Z-axis.

2. The tetra-mirror multi-reflection scanning module of claim 1, wherein the total tracking length of the optical path and the total distance of the four reflection mirrors satisfy the conditions of:
$$0.7 \leq \frac{{D}_{refl}}{2 ( TTL - {D}_{refl} )} \leq 1.0 ;$$
wherein TTL is a total tracking length; D_{refl} is a total distance between the four reflection mirrors along the optical path.

3. The tetra-mirror multi-reflection scanning module of claim 1, wherein the four reflection mirrors are reflection mirror (M1), reflection mirror (M2), reflection mirror (M3) and reflection mirror (M4), constituting an optical path of Li (Obj, a desired scanning document)→M1→M2→M3→M2→M4→Lo (Img, an image sensor), and the reflection mirror (M2) reflects a light for two times.

4. The tetra-mirror multi-reflection scanning module of claim 1, wherein the light source is one selected from the collection of a cold cathode fluorescent lamp, a light emitting diode (LED) lamp and a xenon lamp.
